(19) United States
(12) Patent Application Publication
(10) Pub. No.: US 2024/0413674 A1
(43) Pub. Date: Dec. 12, 2024

(54) STATOR

(71) Applicants: IHI Corporation, Tokyo (JP); NATIONAL UNIVERSITY CORPORATION OKAYAMA UNIVERSITY, Okayama-shi (JP)

(72) Inventors: Fuminori SUZUKI, Tokyo (JP); Takehiro JIKUMARU, Tokyo (JP); Masatsugu TAKEMOTO, Okayama (JP)

(73) Assignees: IHI Corporation, Tokyo (JP); NATIONAL UNIVERSITY CORPORATION OKAYAMA UNIVERSITY, Okayama-shi (JP)

(21) Appl. No.: 18/811,900

(22) Filed: Aug. 22, 2024

Related U.S. Application Data
(63) Continuation of application No. PCT/JP2022/008387, filed on Feb. 28, 2022.

(51) Int. Cl. H02K 1/16; H02K 3/04

(52) U.S. Cl. CPC H02K 1/165; H02K 3/04

(57) ABSTRACT

A stator includes: a stator core (11) including a back yoke (13) provided around an axis and surrounding a rotor (30), and teeth (14) provided at intervals in a circumferential direction of the axis and attached to the back yoke (13), and a coil (12) wound around each of the teeth (14). Each of the teeth (14) has an inner circumferential surface facing the rotor (30) and includes a tip portion (14a) projecting forward and backward in a rotational direction of the rotor (30), and a base portion (14b) facing the back yoke (13). The inner circumferential surface (14c) includes a first region (14d) and a second region (14e). An average interval between the second region (14e) and an outermost locus of the rotor (30) is larger than an average interval between the first region (14d) and the outermost locus of the rotor (30).

### CROSS REFERENCE TO RELATED APPLICATIONS

This application is a continuation application of International Application No. PCT/JP2022/008387, now WO 2023/162257 A1, filed on Feb. 28, 2022, the entire contents of which are incorporated by reference herein.

### TECHNICAL FIELD

The present disclosure relates to a stator of an electric motor or generator.

### BACKGROUND ART

In order to address environmental issues such as global warming, the MEA (more electric aircraft) concept, which is the electrification of aircraft equipment, is being promoted. As part of this, more compact, lightweight, and high power density electric motors are required. For example, it is known to adopt rectangular wires having rectangular cross sections in order to improve the energy efficiency of an electric motor. Specifically, coils (flat-square coils) constituted by rectangular wires are installed on the electric motor, thereby improving the space factor of the coils (see JP 2021-158725 A).

### SUMMARY OF THE INVENTION

Generally, an eddy current is generated in a coil of an electric motor by a magnetic flux from a rotor. When a flat-square coil is used for this coil, the eddy current loss is likely to increase due to the increase in the surface area. Increased eddy current loss is one of the factors that reduce the energy efficiency of the electric motor.

The present disclosure is made in view of the above-mentioned circumstances, and the object of the present disclosure is to provide a stator capable of improving the output power density.

An embodiment of the present disclosure is a stator including: a stator core including a back yoke provided around an axis and surrounding a rotor, and teeth provided at intervals in a circumferential direction of the axis and attached to the back yoke;

and a coil wound around each of the teeth; wherein each of the teeth has an inner circumferential surface facing the rotor and includes a tip portion projecting forward and backward in a rotational direction of the rotor and a base portion facing the back yoke, the inner circumferential surface includes a first region positioned forward in the rotational direction and a second region positioned backward in the rotational direction with respect to the first region, and an average interval between the second region and an outermost locus of the rotor is larger than an average interval between the first region and the outermost locus of the rotor.

The first region of the inner circumferential surface may include a first curved surface having a center of curvature located radially inward from the inner circumferential surface. The second region of the inner circumferential surface may include a second curved surface having a center of curvature located radially outward from the inner circumferential surface. The inner circumferential surface may include a portion orthogonal to a radial direction. The tip portion of each of the teeth may be formed in a flared shape toward the rotor. The coil may be formed of an electric wire having a rectangular cross section. The back yoke may be provided with a groove into which the base portion of each of the teeth is inserted.

According to the present disclosure, it is possible to provide a stator capable of improving the output power density.

### BRIEF DESCRIPTION OF THE DRAWINGS

FIG. 1 is a cross-sectional view of an electric motor with a stator according to an embodiment of the present disclosure.

FIG. 2 is a partial cross-sectional view of a tooth and its surroundings according to an embodiment of the present disclosure.

FIG. 3 is a cross-sectional view of a modified example of a tooth according to an embodiment of the present disclosure.

FIGS. 4A and 4B are analytical results each showing the magnetic flux density distribution around the connection between a back yoke and a tooth, FIG. 4A is the magnetic flux density distribution of the comparative example in which no groove is formed, and FIG. 4B is the magnetic flux density distribution of the present embodiment in which a groove is formed.

### DESCRIPTION OF EMBODIMENTS

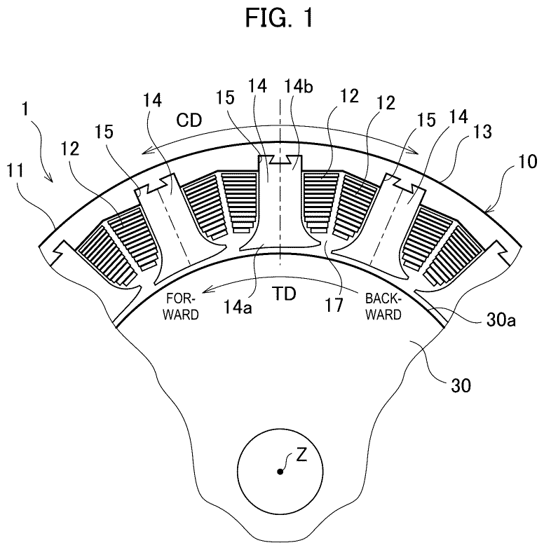

The stator 10 according to some embodiments of the present disclosure will be described below. The same reference numerals will be used for common parts in each figure, and duplicate descriptions will be omitted. For convenience of explanation, a Z-axis will be defined as a reference axis of the whole stator 10. In addition, a circumferential direction CD and a radial direction RD will be defined around a point on the Z-axis. The stator 10 surrounds an outer periphery of the rotor 30. The rotor 30 rotates in a rotation direction TD with the Z axis as the central axis of rotation. The rotation direction TD is counterclockwise in FIG. 1.

The stator 10 and the rotor 30 constitute an electric motor 1. FIG. 1 is a cross-sectional view of an electric motor 1 including the stator 10 according to the present embodiment. This figure shows a cross-sectional view of the electric motor 1 orthogonal to the Z-axis. The electric motor may be a DC electric motor such as an electromagnet field commutator motor or an AC electric motor such as a permanent magnet synchronous motor. The stator 10 and the rotor 30 may constitute a generator such as a permanent magnet synchronous generator.

The stator 10 includes a stator core 11 and a coil 12. The stator core 11 includes a back yoke 13 and a plurality of teeth 14. The back yoke 13 is provided around a Z-axis as a central axis and surrounds the rotor 30. The stator core 11 and the coil 12 are housed in a casing (not shown).

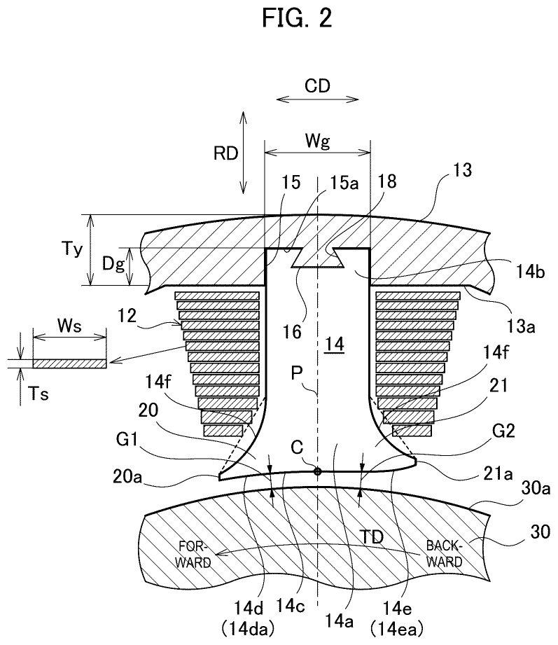

A plurality of grooves 15 are formed on the inner circumferential surface 13a of the back yoke 13. The grooves 15 extend along the Z-axis. A width Wg of the groove 15 along the circumferential direction CD (see FIG. 2) has a value that accommodates the base portion 14b of the tooth 14 and allows the sliding of the tooth 14 along the Z-axis. A depth Dg of the groove 15 along the radial direction RD is set to a value that provides a larger contactable area than a contactable area between the back yoke 13 and the teeth 14 when the teeth 14 are attached to the inner circumferential surface 13a without the grooves 15. For example, the depth Dg of the groove 15 is set to ½ or more of a thickness Ty of the back yoke 13.

FIG. 2 is a partial sectional view of the tooth 14 and its surroundings. As shown in FIG. 2, a projection 16 is formed on a bottom surface 15a of the groove 15. The projection 16 has a cross-sectional shape complementary to that of a dovetail groove 18 (described later) formed on the base portion 14b of the tooth 14. The projection 16 extends along the Z-axis. The base portion 14b of the tooth 14 is inserted into the groove 15 from a direction along the Z-axis. The projection 16 on the back yoke 13 side is engaged with the dovetail groove 18 on the tooth 14 side. In addition, two adjacent teeth 14 attached to the back yoke 13 form a slot 17 between them (see FIG. 1). The slot 17 is a storage space for the coil 12.

As shown in FIG. 1, the teeth 14 are provided at intervals in the circumferential direction CD and extend from the back yoke 13 toward the Z-axis (i.e., radially inward). The intervals (pitches) are equal to the intervals (pitches) of the grooves 15 formed in the back yoke 13. The teeth 14 are attached to the back yoke 13 by engagement of the protrusions 16 and the grooves 15, thereby they are magnetically coupled. The engagement also prevents the teeth 14 from falling off the grooves 15.

As shown in FIG. 2, the tooth 14 have a tip portion 14a facing the rotor 30 and a base portion 14b facing the back yoke 13. The tip portion 14a projects forward and backward in the rotational direction TD (i.e., on both sides of the circumferential direction CD). In other words, the tip portion 14a has a first flange portion 20 projecting forward in the rotational direction TD (i.e., in the counterclockwise direction in FIG. 1) of the rotor 30 and a second flange portion 21 projecting backward in the rotational direction TD. As an example, the tip portion 14a according to the present embodiment is formed in a flared shape toward the rotor 30. Specifically, the tip portion 14a includes a portion whose width along the circumferential direction CD increases as it approaches the rotor 30. This can suppress an excessive increase in magnetoresistance in the tip portion 14a.

The two side surfaces 14f, 14f of the tip portion 14a facing the circumferential direction CD may be concave surfaces recessed toward the vicinity of an intersection line of a center surface P of the tooth 14 and an inner circumferential surface 14c of the tooth 14. Otherwise, as indicated by dashed lines in the figure, they may be planes so that their perpendicular lines passes near the intersection line. In either case, the maximum width of the tip portion 14a along the circumferential direction CD is longer than the width of the base portion 14b along the circumferential direction CD.

The tip portion 14a of the teeth 14 has a first side portion 20a and a second side portion 21a. The first side portion 20a is a part of the first flange portion 20 and is positioned most forward in the rotation direction TD of the rotor 30. That is, the first side portion 20a is located on the most downstream side in the rotational direction TD (the most left side in FIG. 2). The first side portion 20a may be formed continuously with the inner circumferential surface 14c as a part of the inner circumferential surface 14c. Otherwise, the first side portion 20a may be formed as an end face of the first flange portion 20 facing forward of the rotation direction TD.

The second side portion 21a is a part of the second flange portion 21 and is located most rearward in the rotation direction TD. That is, the second side portion 21a is located on the most upstream side in the rotational direction TD (the most right side in FIG. 2). As similar to the first side portion 20a, the second side portion 21a may be formed continuously with the inner circumferential surface 14c as a part of the inner circumferential surface 14c, or may be formed as an end face of the second flange portion 21 facing the rear of the rotation direction TD.

The tip portion 14a of the tooth 14 has an inner circumferential surface 14c facing the rotor 30. The inner circumferential surface 14c extends from the first side portion 20a to the second side portion 21a. The inner circumferential surface 14c includes a first region 14d and a second region 14e. The first region 14d is located forward in the rotational direction TD and extends from the first side portion 20a toward the second side portion 21a. The second region 14e is positioned backward in the rotational direction TD with respect to the first region 14d and extends from the first region 14d to the second side portion 21a.

An average interval between the second region 14e and an outermost locus of the rotor 30 is larger than an average interval between the first region 14d and the outermost locus of the rotor 30. Here, the average interval is a value obtained by averaging the shortest distance from each position on one region to the outermost locus of the rotor 30 when rotated, along the circumferential direction CD (rotation direction TD). For example, when the cross section of the rotor 30 is a perfect circle, the outermost locus of the rotor 30 coincides with the outer circumferential surface 30a of the rotor 30. In any case, the second region 14e includes more portions away from the rotor 30 than the first region 14d.

For convenience of explanation, the connection point (boundary) C of the first region 14d and the second region 14e is defined in the cross section orthogonal to the Z axis. The connection point C is located on the center plane P of the tooth 14. An extension plane of the center plane P passes through the Z-axis. In other words, the Z-axis is included in the extension plane of the center plane P. The position of the connection point C is not limited to a position on the center plane P.

The first region 14d may include a first curved surface 14da. The first curved surface 14da has at least one center of curvature located radially inward from the inner circumferential surface 14c. Here, having the center of curvature radially inward (or radially outward) means that a line segment connecting between a point on the first curved surface 14da and the center of curvature extends radially inward (or radially outward) from the point on the first curved surface 14da. For example, only one center of curvature of the first curved surface 14da is located on the Z axis. In this case, the first curved surface 14da is formed in an arc shape, and the first curved surface 14da and the outermost locus of the rotor 30 (e.g., the outer circumferential surface 30a) are located concentrically. That is, the distance from the first curved surface 14da to the outermost locus of the rotor 30 is constant at each position on the first curved surface 14da along the circumferential direction CD. The inner circumferential surface 14c includes a portion orthogonal to the radial direction RD at the connection point C. In the present embodiment, since the connection point C is located on the center surface P, the inner circumferential surface 14c is orthogonal to the center surface P of the tooth 14 at the connection point C. The first region 14d according to the present embodiment is represented as the first curved surface 14da by a smooth arc-shaped curve in the cross section orthogonal to the Z-axis (rotation center axis). However, the first curved surface 14da may be represented by a curve formed by bending and connecting a plurality of curves having their respective curvature centers located radially inwardly in the cross section orthogonal to the z-axis (rotation center axis). That is, the first curved surface 14da may form a curved surface having a curvature center located radially inwardly as a whole, and may have a plurality of curved surfaces (not shown) that are bent and connected at connection points between each other.

The second region 14e may include the second curved surface 14ea. The second curved surface 14ea has at least one center of curvature located radially outward from the inner circumferential surface 14c. That is, the second curved surface 14ea is curved in a direction opposite to a direction in which the outermost locus (e.g., the outer circumferential surface 30a) of the rotor 30 is curved, and is formed in a reverse arc shape with respect to the first curved surface 14da. Accordingly, the distance between the second curved surface 14ea and the outermost locus of the rotor 30 gradually increases as it approaches the second side portion 21a from the connection point C. This increase rate is larger as it approaches the second side portion 21a. The second region 14e of the present embodiment is represented as the second curved surface 14ea by a smooth arc-shaped curve in a cross section orthogonal to the z-axis (rotation center axis). However, the second curved surface 14ea may be represented by a curve formed by bending and connecting a plurality of curves having their respective curvature centers located radially outward in a cross section orthogonal to the Z-axis (rotation center axis). That is, the second curved surface 14ea may form a curved surface having a curvature center located radially outward as a whole, and may have a plurality of curved surfaces (not shown) that are bend and connected at connection points between each other.

The surface shape of the first region 14d is not limited to such an arc-shaped surface and may be arbitrarily defined as long as the distance relationship described above is satisfied. For example, the first region 14d may include one or more planes. That is, the first region 14d may be represented by one or more straight lines in a cross section orthogonal to the Z-axis (rotation center axis). In the latter case, the first region 14d may have a plurality of planes (not shown) that are bent and connected at their connection points to form a curved surface having a center of curvature located radially inward as a whole.

Similarly, the second region 14e may include one or more planes. That is, the second region 14e may be represented by one or more straight lines in a cross section orthogonal to the Z-axis (rotation center axis). In the latter case, the second curved surface 14ea may have a plurality of planes (not shown) that are bent and connected at their connection points to form a curved surface having a center of curvature located radially outward as a whole.

The coil 12 is wound around the tooth 14 and accommodated in slot 17. The coil 12 is formed of an electric wire having a rectangular cross section. That is, the coil 12 is a so-called flat-square coil. The coil 12 is wound around the tooth 14 and stacked in the radial direction RD. The electric wire used for the coil 12 is often a plate or a flat bar having a predetermined thickness. However, these are called “electric wires” for convenience.

As described above, the tooth 14 includes the tip portion 14a which is formed in a flared shape. That is, the width of the slots 17 along the circumferential direction CD becomes narrower as it becomes closer to the rotor 30. Thus, the coil 12 has a width and thickness that match the shape of the slot 17. Specifically, as shown in FIG. 2, the width Ws of the wire along the circumferential direction CD is narrower than that of the wire wound closer to the rotor 30. However, the thickness Ts of the wire along the radial direction RD is thicker than that of the wire wound closer to the rotor 30.

The eddy current loss in the wire tends to increase as the wire wound gets closer to the rotor 30. Therefore, the width Ws of the electric wire is made narrower as the electric wire wound gets closer to the rotor 30, thereby reducing the magnetic flux through the electric wire. On the other hand, the thickness of the electric wire is made thicker as the electric wire wound gets closer to the rotor 30, thereby suppressing the increase in electrical resistance. By setting such width and thickness, the space factor in the slot 17 is increased and the efficiency is improved while suppressing the excessive increase in eddy current loss and copper loss.

As described above, the width Ws and the thickness Ts of the wire of the coil 12 change with each winding. When such a coil 12 is manufactured, for example, a strip-shaped conductor having a desired width Ws and thickness Ts is formed for each winding. These conductors are stacked in the direction of the thickness Ts and joined to be formed in a spiral shape. Parts of these conductors other than those to be joined are electrically insulated from each other. The coil 12 is attached to the back yoke 13 together with the tooth 14 in a state where it has been attached to the tooth 14 in advance. Since the change in the width Ws and the thickness Ts of the electric wire close to the back yoke 13 is relatively small, the width Ws and the thickness Ts may be constant for a predetermined winding number.

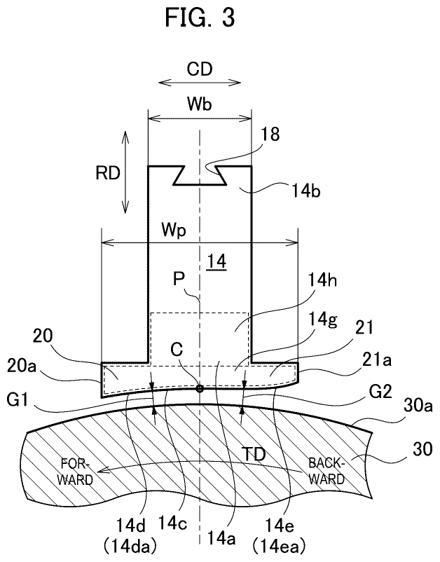

FIG. 3 is a cross-sectional view of a modified example of the tooth 14. As shown in this figure, the tip portion 14a of the teeth 14 may have a shape whose width along the circumferential direction CD changes stepwise as the width it approaches the rotor 30. For example, as shown in FIG. 3, the tip portion 14a has a first portion 14g and a second portion 14h. The first portion 14g includes an inner circumferential surface 14c, a first side portion 20a, and a second side portion 21a. The second portion 14h is located closer to the base portion 14b than the first portion 14g. The width of the second portion 14h along the circumferential direction CD is equal to the width Wb of the base portion 14b. The first portion 14g is provided with a first flange portion 20 having the first side portion 20a and a second flange portion 21 having the second side portion 21a. The width Wp of the first portion 14g is larger than the width of the second portion 14h. Also in this modified example, the average interval between the second region 14e of the inner circumferential surface 14c and the outermost locus of the rotor 30 is larger than the average interval between the first region 14d of the inner circumferential surface 14c and the outermost locus of the rotor 30. The thickness of the first portion 14g along the radial direction RD is set to a value at which magnetic saturation is unlikely to occur, depending on the assumed magnetic flux.

The magnetoresistance between the rotor and the tooth is smaller as the distance between them is narrower. Therefore, the magnetic flux of the rotor can be increased by setting the tooth closer to the rotor. As a result, the torque can be increased. However, if the magnetic flux in the tooth is excessively increased, magnetic saturation occurs in the tooth and the leakage magnetic flux through the windings increases. As a result, the eddy current loss in the windings increases. In general, the magnetic flux in the tooth tends to be larger on the side where the magnetic flux of the rotor approaches, and smaller on the side where the magnetic flux of the rotor moves away.

The tip portion 14a of the teeth 14 according to the present embodiment has the inner circumferential surface 14c in which the average interval between the second region 14e and the outermost locus of the rotor 30 is larger than the average interval between the first region 14d and the outermost locus of the rotor 30. That is, when considering the rotation of the rotor 30, the second flange portion 21 is located on the side where the magnetic flux of the rotor 30 approaches (i.e., the side where the magnetic flux penetrating the inside is large), and the first flange portion 20 is located on the side where the magnetic flux of the rotor 30 move away (i.e., the side where the magnetic flux penetrating the inside is small).

Therefore, the magnetoresistance between the second flange portion 21 and the rotor 30 increases, and the magnetic saturation flange portion 21 is suppressed. With this, the leakage magnetic flux can be reduced and the eddy current loss in the coil 12 can be reduced. For example, when a flat-square coil is used as the coil 12, the loss in the coil 12 is dominated by eddy current loss. The reduction in the eddy current loss effectively reduces the total loss in the coil 12.

However, when the average interval between the second region 14e and the outermost locus of the rotor 30 increases, the torque obtained by the second flange portion 21 is reduced. To compensate this reduction, the average interval between the first region 14d and the outermost locus of the rotor 30 is set smaller than the average interval between the second region 14e and the outermost locus of the rotor 30. With this, the magnetoresistance between the first flange portion 20 and the rotor 30 decreases more than that between the second flange portion 21 and the rotor 30, and the magnetic flux of the rotor 30 passing through the first flange portion 20 increases. The magnetic flux passing through the first flange portion 20 is relatively smaller than that passing through the second flange portion 21. Therefore, the magnetic saturation in the first flange portion 20 is less likely to occur than that in the second flange portion 21. Accordingly, by setting the first side portion 20a closer to the rotor 30 than the second side portion 21a, it possible to suppress the occurrence of magnetic saturation in the first flange portion 20 while increasing the torque by capturing the magnetic flux.

As described above, in the present embodiment, the first side portion 20a of the first flange portion 20 and the second side portion 21a of the second flange portion 21 are positioned to compensate an increase or decrease in torque and an increase or decrease in eddy current loss. Consequently, the output power density can be improved and miniaturization can be achieved compared with an electric motor of the same size.

For convenience in assembling the coil 12 into the back yoke 13, the tooth 14 and the back yoke 13 are mutually separated. Accordingly, a small unavoidable gap is formed where they connect with each other, and this gap increases magnetoresistance. This increase in magnetoresistance causes an increase in leakage magnetic flux and increases the eddy current loss in the wire of the flat-square coil close to the back yoke 13.

In the present embodiment, the inner circumferential surface 13a of the back yoke 13 is provided with the groove 15 formed thereon, into which the base portion 14b of the tooth 14 is inserted. As described above, the depth Dg of the groove 15 is set to a value that provides a larger contactable area than a contactable area between the back yoke 13 and the tooth 14 when the tooth 14 is attached to the inner circumferential surface 13a without the grooves 15. That is, the area where the back yoke 13 and the tooth 14 come into contact with each other or face each other increases. With this, the magnetoresistance between the back yoke 13 and the tooth 14 can be reduced. Since the magnetoresistance is reduced, the leakage magnetic flux is reduced, and the eddy current loss in the wire of the flat-square coil close to the back yoke 13 can be reduced.

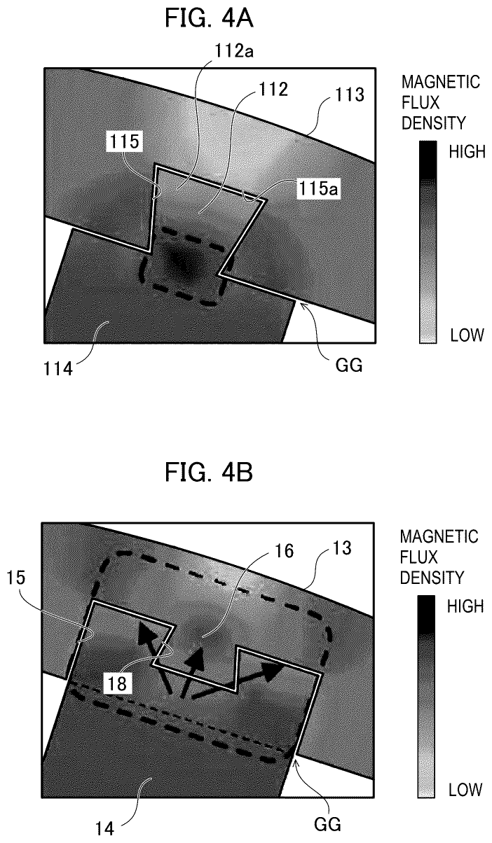

FIGS. 4A and 4B are analysis results each showing the magnetic flux density distribution around the connection part between the back yoke and the tooth. FIG. 4A is the magnetic flux density distribution of the comparative example in which the groove 15 is not formed. FIG. 4B is the magnetic flux density distribution of the present embodiment in which the groove 15 is formed. As shown in FIG. 4A, a gap GG increasing the magnetoresistance exists between the back yoke 113 and the tooth 114. The magnetic flux of the tooth 114 is temporarily concentrated near the root of the projection 112 inserted into the groove 115 of the back yoke 113 due to the existence of the gap GG. In addition, it is assumed that the gap GG is also generated between the tip 112a of the projection 112 and the bottom surface 115a of the groove 115. Therefore, the direction of the concentrated magnetic flux is forcibly deflected in the circumferential direction. Such concentration and deflection of the magnetic flux can be a factor to increase the leakage magnetic flux.

On the other hand, even in the present embodiment shown in FIG. 4B, there can be a gap GG between the back yoke 13 and the tooth 14 to increase the magnetoresistance. However, with the increase in the contactable area between them, the magnetoresistance decreases, the magnetic flux is moderately dispersed in the direction indicated by arrows, and excessive concentration of the magnetic flux is suppressed. Accordingly, the leakage magnetic flux is reduced and the eddy current loss in the coil 12 is reduced. Consequently, the output power density can be improved.

The coil 12 may be formed of an electric wire having a circular cross section that is wound by a known method. However, when the coil 12 is a flat square coil, the space factor in the slot 17 can be increased more than when the coil 12 is formed of the electric wire having the circular cross section.

It should be noted that the present disclosure is not limited to the foregoing embodiments, but is indicated by the description of the claims, and further includes all changes within the meaning and scope of the description and equality of the claims.

What is claimed is:

1. A stator comprising:
a stator core including a back yoke provided around an axis and surrounding a rotor, and teeth provided at intervals in a circumferential direction of the axis and attached to the back yoke; and
a coil wound around each of the teeth; wherein
each of the teeth has an inner circumferential surface facing the rotor and includes a tip portion projecting forward and backward in a rotational direction of the rotor and a base portion facing the back yoke,
the inner circumferential surface includes a first region positioned forward in the rotational direction and a second region positioned backward in the rotational direction with respect to the first region, and
an average interval between the second region and an outermost locus of the rotor is larger than an average interval between the first region and the outermost locus of the rotor.

2. The stator according to claim 1, wherein
the first region of the inner circumferential surface includes a first curved surface having a center of curvature located radially inward from the inner circumferential surface; and
the second region of the inner circumferential surface includes a second curved surface having a center of curvature located radially outward from the inner circumferential surface.

3. The stator according to claim 2, wherein
the inner circumferential surface includes a portion orthogonal to a radial direction.

4. The stator according to claim 1, wherein
the tip portion of each of the teeth is formed in a flared shape toward the rotor.

5. The stator according to claim 2, wherein
the tip portion of each of the teeth is formed in a flared shape toward the rotor.

6. The stator according to claim 3, wherein
the tip portion of each of the teeth is formed in a flared shape toward the rotor.

7. The stator according to claim 1, wherein
the coil is formed of an electric wire having a rectangular cross section.

8. The stator according to claim 1, wherein
the back yoke is provided with a groove into which the base portion of each of the teeth is inserted.

9. The stator according to claim 2, wherein
the back yoke is provided with a groove into which the base portion of each of the teeth is inserted.

10. The stator according to claim 3, wherein
the back yoke is provided with a groove into which the base portion of each of the teeth is inserted.

11. The stator according to claim 4, wherein
the back yoke is provided with a groove into which the base portion of each of the teeth is inserted.

12. The stator according to claim 5, wherein
the back yoke is provided with a groove into which the base portion of each of the teeth is inserted.

13. The stator according to claim 6, wherein
the back yoke is provided with a groove into which the base portion of each of the teeth is inserted.

14. The stator according to claim 7, wherein
the back yoke is provided with a groove into which the base portion of each of the teeth is inserted.
